(19) United States
(12) Patent Application Publication
(10) Pub. No.: US 2014/0164161 A1
(43) Pub. Date: Jun. 12, 2014

(54) METHOD AND TERMINAL FOR PROCESSING AN ELECTRONIC TICKET

(71) Applicant: TENCENT TECHNOLOGY (SHENZHEN) COMPANY LIMITED, Shenzhen (CN)

(72) Inventors: BIFENG ZHANG, Shenzhen (CN); SHILI LIN, Shenzhen (CN); HUAFENG MA, Shenzhen (CN); KUN ZHANG, Shenzhen (CN); TONGYI GUO, Shenzhen (CN); XIAO XIAO, Shenzhen (CN); QILIANG CHEN, Shenzhen (CN)

(73) Assignee: TENCENT TECHNOLOGY (SHENZHEN) COMPANY LIMITED, Shenzhen (CN)

(21) Appl. No.: 14/142,852

(22) Filed: Dec. 29, 2013

Related U.S. Application Data
(63) Continuation of application No. PCT/CN2013/084511, filed on Sep. 27, 2013.

(30) Foreign Application Priority Data
Dec. 10, 2012 (CN) 201210526788.0

(51) Int. Cl. G06Q 30/06

(52) U.S. Cl. CPC G06Q 30/0601
USPC 705/26.1

(57) ABSTRACT

Methods and terminals for processing e-tickets are provided. The terminal can include a saving module, a parsing module, and a voice reading module. The e-ticket can be obtained by a terminal. The terminal can parse contents of the e-ticket to generate ticket information of the e-ticket by triggering a reading button to call an internal program. The ticket information can be converted by the terminal into a voice message corresponding to the e-ticket. The voice message can be played by the terminal to read the ticket information of the e-ticket.

### CROSS-REFERENCES TO RELATED APPLICATIONS

This application is a continuation application of PCT Patent Application No. PCT/CN2013/084511, filed on Sep. 27, 2013 which claims priority to Chinese Patent Application No. CN201210526788.0, filed on Dec. 10, 2012, the entire contents of all of which are incorporated herein by reference.

### FIELD OF THE DISCLOSURE

The disclosure relates to the field of Internet technology and, more particularly, relates to methods and terminals for processing electronic tickets (e-tickets).

### BACKGROUND

In today's age of electronic commerce (e-commerce), more and more users would use online shopping. In order to attract the users to purchase more, sellers may send out promotional e-tickets such as e-discount coupons and e-vouchers in various forms for e-media production, spreading, and use. After a user is registered or purchased on a shopping site, the seller may use SMS (i.e., short message service) or MMS (i.e., multimedia messaging service) to send the promotional e-tickets to the registered user terminal via Internet or mobile networks. In addition, the users can search and download the promotional e-tickets (e.g., including MMS coupons, SMS coupons, or mobile phone e-coupons) provided by the sellers via mobile SMS and the Internet.

The e-tickets provided by the sellers may include SMS or MMS coupons containing a string of a code or a serial number, representing ticket information or consumer information of the user. Therefore, when a user uses e-tickets, the seller has to check the code or the serial number directly from the user's terminal. Or the user needs to orally provide the code or the serial number of the e-tickets from the terminal such that the seller can examine whether the e-tickets meet requirements for use. However, when the user orally provides the code or the serial number of the e-tickets, errors may occur due to human negligence in reading (e.g., being mistakenly read, missed reading, and/or being overly read) or due to dialect accent differences. To correct errors, the code or the serial number often need to be repeatedly inputted. This may cause significant inconvenience in using the e-tickets and may not meet consumption needs.

### BRIEF SUMMARY OF THE DISCLOSURE

One aspect of the present disclosure includes a method for processing an e-ticket. The e-ticket can be obtained by a terminal. The terminal can parse contents of the e-ticket to generate ticket information of the e-ticket by triggering a reading button to call an internal program. The ticket information can be converted by the terminal into a voice message corresponding to the e-ticket. The voice message can then be played by the terminal to read the ticket information of the e-ticket.

Another aspect of the present disclosure includes a terminal for processing an e-ticket. The terminal can include a saving module, a parsing module, and a voice reading module. The saving module can be configured to receive the e-ticket. The parsing module can be configured to parse contents of the e-ticket to generate ticket information of the e-ticket by triggering a reading button to call an internal program and to convert the ticket information into a voice message corresponding to the e-ticket. The voice reading module can be configured to play the voice message to read the ticket information of the e-ticket.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for processing an e-ticket in accordance with various disclosed embodiments;

FIG. 2 depicts another exemplary method for processing an e-ticket in accordance with various disclosed embodiments;

FIG. 3 depicts an exemplary terminal for processing an e-ticket in accordance with various disclosed embodiments;

FIG. 4 depicts an exemplary environment incorporating certain disclosed embodiments; and

FIG. 5 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

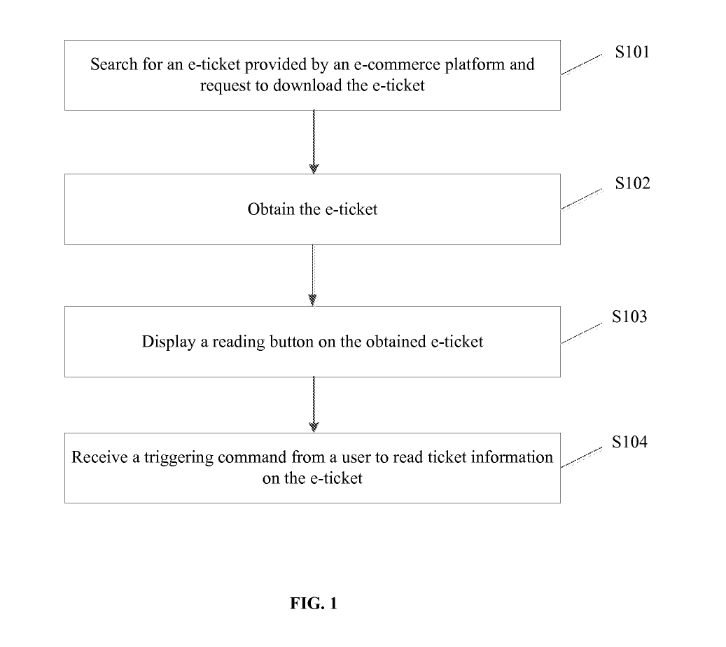

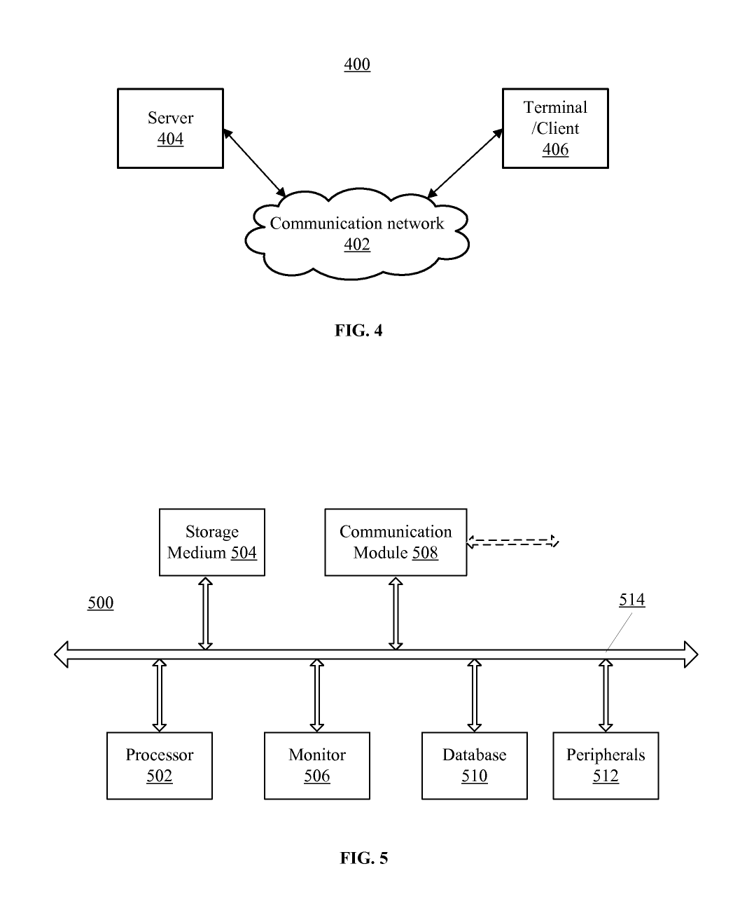

FIGS. 1-3 depict exemplary methods and terminals for processing electronic tickets (e-tickets) in accordance with various disclosed embodiments. The exemplary methods and terminals can be implemented, for example, in an exemplary environment 400 as shown in FIG. 4.

As shown in FIG. 4, the environment 400 can include a server 404, a terminal 406, and a communication network 402. The server 404 and the terminal 406 may be coupled through the communication network 402 for information exchange, for example, Internet searching, webpage browsing, etc. Although only one terminal 406 and one server 404 are shown in the environment 400, any number of terminals 406 or servers 404 may be included, and other devices may also be included.

The communication network 402 may include any appropriate type of communication network for providing network connections to the server 404 and terminal 406 or among multiple servers 404 or terminals 406. For example, the communication network 402 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be used interchangeably. In various embodiments, the terminal 406 can be used to process e-tickets and to receive voice notes from another terminal.

A server, as used herein, may refer one or more server computers configured to provide certain server functionalities, for example, search engines and database management. A server may also include one or more processors to execute computer programs in parallel.

The server 404 and the terminal 406 may be implemented on any appropriate computing platform. FIG. 5 shows a block diagram of an exemplary computing system 500 capable of implementing the server 404 and/or the terminal 406. As shown in FIG. 5, the exemplary computer system 500 may include a processor 502, a storage medium 504, a monitor 506, a communication module 508, a database 510, peripherals 512, and one or more bus 514 to couple the devices together. Certain devices may be omitted and other devices may be included.

The processor 502 can include any appropriate processor or processors. Further, the processor 502 can include multiple cores for multi-thread or parallel processing. The storage medium 504 may include memory modules, for example, ROM, RAM, and flash memory modules, and mass storages, for example, CD-ROM, U-disk, removable hard disk, etc. The storage medium 504 may store computer programs for implementing various processes, when executed by the processor 502.

Further, the peripherals 512 may include I/O devices, for example, keyboard and mouse, and the communication module 508 may include network devices for establishing connections through the communication network 402. The database 510 may include one or more databases for storing certain data and for performing certain operations on the stored data, for example, webpage browsing, database searching, e-ticket searching, etc.

In operation, the terminal 406 may cause the server 404 to perform certain actions, for example, an Internet search or other database operations. The server 404 may be configured to provide structures and functions for such actions and operations. More particularly, the server 404 may include a data searching system for real-time database searching. In various embodiments, a terminal, for example, a mobile terminal involved in the disclosed methods and systems can include the terminal 406.

As disclosed, methods and terminals for processing electronic tickets (e-tickets) are provided. For example, code and/or serial numbers of an e-ticket can be read by a voice message. This solves the problems that the user may not correctly obtain the ticket information including the code and/or serial numbers due to errors caused by human negligence or due to dialect accent differences. The disclosed methods and terminals for processing e-tickets can be used in e-commerce platforms including, e.g., B2B platforms, B2C platforms, N2C platforms, independent network shopping centers, group buying websites, and/or other suitable platforms.

FIG. 1 depicts an exemplary method for processing an e-ticket in accordance with various disclosed embodiments.

In Step S101, e-tickets provided by e-commerce platforms can be searched and requested to be downloaded. In various embodiments, the e-ticket can include a promotional e-certificate or any suitable e-document which may be in various electronic media forms (e.g., including two-dimensional barcode, images, etc.) for production, spreading, and use. Such promotional e-certificate can include, e.g., an e-discount coupon, an e-voucher, an e-movie ticket, and/or any other suitable electronic (e-) promotional tickets.

In Step S102, an e-ticket can be obtained. In one embodiment, the e-ticket can be downloaded to a user's terminal (e.g., a smart phone, a tablet computer, etc.) via a wireless local area network (WLAN) such as a Wi-Fi network, a Bluetooth communication network, a near field communication (NFC) network, etc. The e-ticket can be saved on the terminal.

In Step S103, a reading button can be displayed on the e-ticket. For example, the reading button can be configured near a code or a serial number displayed on the page of the e-ticket. In some cases, when an e-movie ticket has a serial number SZ815109LH0508e on the page, the reading button can be located next to the serial number SZ815109LH0508e. In one embodiment, the reading button can be a physical button and/or can be configured including a software touch-control button that is similar to a “music player key”. The reading button can receive a triggering command or a triggering operation from a user, for example, to call an internal program, e.g., that is installed in the terminal, to parse contents of the e-ticket to obtain ticket information of the e-ticket. The ticket information including, e.g., the code, the serial number, and/or other information of the e-ticket can then be converted into a corresponding voice message.

In Step S104, a triggering command can be received from the user and the ticket information on the e-ticket can be read. For example, the reading button displayed on the e-ticket may respond to the triggering command or the triggering operation from the user, which can output the ticket information of the e-ticket in a form of a voice message. The ticket information can include a string of the code or the serial number arranged in a specific format and/or a specific order. Such code and/or serial number can be formed by letter(s) and/or number(s) to indicate the ticket information or the consumption information the user.

In the disclosed exemplary method, a reading button can be displayed on an e-ticket. By triggering the reading button to output ticket information on the e-ticket as a voice message, problems that the user may not correctly obtain the ticket information due to errors caused by human negligence (e.g., being mistakenly read, missed reading, and/or being overly read) or due to dialect accent differences can be solved to improve the operational efficiency, to meet user's needs, and to provide conveniences.

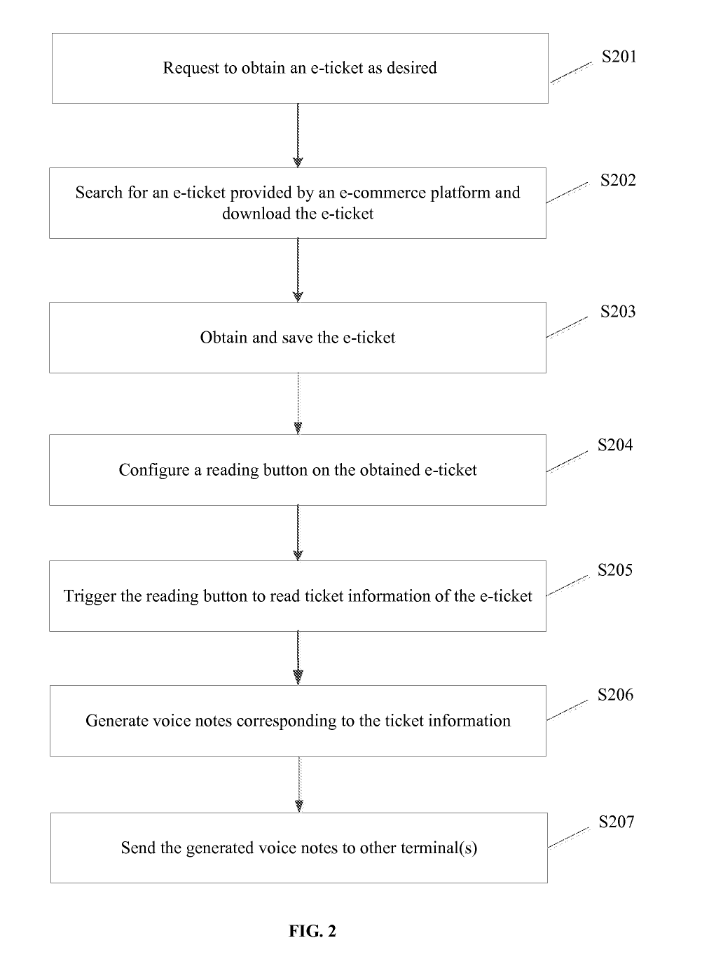

FIG. 2 depicts another exemplary method for processing an e-ticket in accordance with various disclosed embodiments.

In Step S201, an e-ticket as desired can be requested to obtain. As disclosed, the e-ticket can include a promotional e-certificate or any suitable e-document which may be in various electronic media forms (e.g., including two-dimensional barcode, images, etc.) for production, spreading, and use. Such promotional e-certificate can include, e.g., an e-discount coupon, an e-voucher, an e-movie ticket, and/or any other suitable electronic (e-) promotional tickets.

For illustration purposes, the present disclosure is described using an e-movie ticket as an exemplary e-ticket. A user may use a terminal to request to obtain an e-ticket as desired and send a request for obtaining the e-ticket to a corresponding e-commerce platform via the Internet.

In Step S202, e-tickets provided by e-commerce platforms can be searched and downloaded. In one embodiment, according to the desired e-ticket, the user can send a request for obtaining an e-ticket from e-commerce platforms via the Internet and search for the desired e-ticket from the web pages provided by the e-commerce platforms. After the desired e-ticket is selected, the user can request to download the e-ticket. The e-ticket can be a promotional e-ticket containing a string of a code or a serial number arranged in a specific format. Such code and/or serial number can be formed by letter(s) and/or number(s). For example, an e-movie ticket can be denoted by a code or a serial number SZ815109LH0508.

In Step S203, the e-ticket can be obtained and saved. In one embodiment, the e-ticket can be downloaded to a user's terminal (e.g., a smart phone, a tablet computer, etc.) via a wireless local area network (WLAN) such as a Wi-Fi network, a Bluetooth communication network, a near field communication (NFC) network, etc. The e-ticket can be saved on the terminal.

In an exemplary embodiment, by using a wepull system server, e-movie tickets can be obtained from Internet interface. After the user selects the e-movie ticket from the Internet interface, the user can send a message instruction to the wepull system server. The wepull system server can then pull the selected e-movie ticket according to the message instruction; save the pulled e-movie ticket; download the e-movie ticket to the user's terminal (e.g., a smart phone), e.g., via bluetooth, Wi-Fi, or NFC network; and save the e-movie ticket on the user's terminal for a later use.

In Step S204, a reading button can be configured on a page of the obtained e-ticket. For example, the reading button can be configured near a code or serial number on the page of the e-ticket. In some cases, when an e-movie ticket has a serial number SZ815109LH0508e on the page, the reading button can be located next to the serial number SZ815109LH0508e. In one embodiment, the reading button can be a physical button and/or can be configured including a software touch-control button that is similar to a “music player key”. The user can, for example, press or trigger the reading button to call an internal program to parse contents of the e-ticket to obtain ticket information of the e-ticket and to convert the code, the serial number, and/or other ticket information of the e-ticket into a corresponding voice message.

In Step S205, the reading button can be triggered to read the ticket information of the e-ticket. In one embodiment, the user can, for example, press or trigger the reading button configured on the e-ticket to call an internal program to have the terminal to output the ticket information by the voice message. The ticket information can include a string of a code or a serial number arranged in a specific format and/or a specific order. Such code and/or serial number can be formed by letter(s) and/or number(s) to indicate the ticket information or the consumption information of the user.

Specifically, single voice word corresponding to each character in the e-ticket can be searched and found. According to an arranged order of each character in the e-ticket, the single voice words can be combined to form a corresponding voice word string and then can form the voice message corresponding to the e-ticket.

For example, a user can press or trigger the exemplary serial number SZ815109LH0508 of the e-movie ticket located next to the reading button. The reading button can then search for the single voice word corresponding to each character in the serial number, and then call and read the internal voice procedures, according to the arranged order of each character (e.g., from left to right) to combine the found single voice words into a corresponding voice word string, and thus to form the voice message corresponding to the ticket information. In this manner, the terminal can sequentially read the serial number in a form of voice message, according to the arranged order (e.g., from left to right) of the serial number. In various embodiments, the serial number of the e-movie ticket can include ticket information including location, ticket price, theater, seat, and/or other possible ticket information.

In Step S206, voice notes can be generated corresponding to the ticket information. In one embodiment, the terminal can output the ticket information of the e-ticket in the form of voice message and then generate an audio file in a general (e.g., commonly-used) format by recording the voice message of the ticket information. That is, the terminal can generate voice notes corresponding to the ticket information read by the voice message to save on the terminal. Specifically, the audio file can be in a format including a PCM (pulse code modulation) format, a WAV (wave audio files) format, an ADPCM format, an MP3 (moving picture experts group audio layer III) format, etc.

In Step S207, the generated voice notes can be sent to other terminal(s). In one embodiment, the user can send the voice notes saved on the terminal to one or more other terminals and to share with other users via an email and/or an MMS, or via Bluetooth, NFC, or Wi-Fi transmissions. In addition, the generated voice notes can be in a general format of audio files. In the case even if other terminals do not have or are not configured with a reading button, the ticket information of the e-ticket can be read by calling an audio play function in their own system. In other words, terminals that do not have the reading button can play the received voice notes to obtain the ticket information of the e-ticket.

In the disclosed method for processing the e-ticket, the reading button can be displayed on the page of the e-ticket. By triggering the reading button, the ticket information of the e-ticket can be outputted by a voice message. This resolves the problems that the user may not correctly obtain the ticket information from the e-ticket due to errors caused by human negligence or dialect accent differences. Operational efficiency can be improved to meet user's needs and to provide conveniences. In addition, by generating voice notes in a general format from the ticket information, the voice notes can be sent to other terminals that do not have or are not configured with the reading button. The other terminals can also read the ticket information by calling an audio play function in an own system.

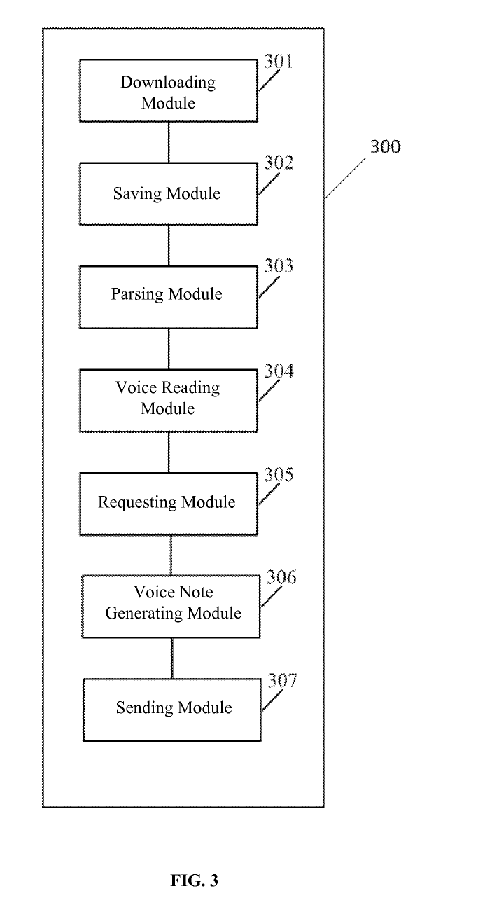

FIG. 3 depicts an exemplary terminal for processing an e-ticket in accordance with various disclosed embodiments. The exemplary terminal can read the e-ticket by a voice message. The exemplary terminal can include a downloading module 301, a saving module 302, a parsing module 303, and/or a voice reading module 304.

The downloading module 301 can be configured to search for an e-ticket provided by an e-commerce platform and to request to download the e-ticket. For example, the e-ticket can include a promotional e-certificate or any suitable e-document which may be in various electronic media forms (e.g., including two-dimensional barcode, images, etc.) for production, spreading, and use. Such promotional e-certificate can include, e.g., an e-discount coupon, an e-voucher, an e-movie ticket, and/or any other suitable electronic (e-) promotional tickets.

For illustration purposes, the present disclosure is described using an e-movie ticket as an exemplary e-ticket. In one embodiment, according to the desired e-ticket, the user can send a request for obtaining the e-ticket to e-commerce platforms via the Internet and search for the desired e-ticket from the web pages provided by the e-commerce platforms. After the desired e-ticket is selected, the user can request to download the e-ticket. The e-ticket can be a promotional e-ticket containing a string of a code or a serial number arranged in a specific format and/or in a specific order. Such code and/or serial number can be formed by letter(s) and/or number(s). For example, an e-movie ticket can be denoted by a code or a serial number SZ815109LH0508.

The saving module 302 can be configured to receive and save the e-ticket. In one embodiment, the e-ticket (e.g., an e-movie ticket having a serial number SZ815109LH0508) can be downloaded to a user's terminal (e.g., a smart phone, a tablet computer, etc.) via a wireless local area network (WLAN) such as a Wi-Fi network, a Bluetooth communication network, a near field communication (NFC) network, etc. The e-ticket can be saved on the terminal.

In an exemplary embodiment, by using a wepull system server, e-movie tickets can be obtained from Internet interface. After the user selects the e-movie ticket from the Internet interface, the user can send a message instruction to the wepull system server. The wepull system server can then pull the selected e-movie ticket according to the message instruction; save the pulled e-movie ticket; download the e-movie ticket to the user's terminal (e.g., a smart phone), e.g., via bluetooth, Wi-Fi, or NFC network; and save the e-movie ticket on the user's terminal for a later use.

The parsing module 303 can be configured to display the obtained e-ticket and the reading button on the e-ticket. For example, the reading button can be configured near a code or serial number on the page of the e-ticket. In some cases, when an e-movie ticket has a serial number SZ815109LH0508e on the page, the reading button can be located next to the serial number SZ815109LH0508e. In one embodiment, the reading button can be a physical button and/or can be configured including a software touch-control button that is similar to a “music player key”. The user can, for example, press or trigger the reading button to call an internal program to parse contents of the e-ticket to obtain ticket information of the e-ticket and to convert the code, the serial number, and/or other ticket information of the e-ticket into a corresponding voice message.

Specifically, single voice word corresponding to each character in the e-ticket can be searched and found. According to an arranged order of each character in the e-ticket, the single voice words can be combined to form a corresponding voice word string and then can form the voice message corresponding to the e-ticket.

The voice reading module 304 can be configured to read the ticket information of the e-ticket. The reading button can receive a triggering command or a triggering operation from a user. The voice reading module 304 can to call an internal program such that the terminal can output the ticket information of the e-ticket in a form of voice message. The ticket information can include a string of a code or a serial number arranged in a specific format and/or a specific order. Such code and/or serial number can be formed by letter(s) and/or number(s) to indicate the ticket information or the consumption information of the user.

For example, a user can press or trigger the exemplary serial number SZ815109LH0508 of the e-movie ticket located next to the reading button. The voice reading module 304 can find the single voice word corresponding to each character in the serial number, and then call and read the internal voice program, according to the arranged order of each character (e.g., from left to right) to combine the found single voice words into a corresponding voice word string, and thus to form the voice message corresponding to the ticket information. In this manner, the terminal can sequentially read the serial number in a form of voice message, according to the arranged order (e.g., from left to right) of the serial number. In various embodiments, the serial number of the e-movie ticket can include ticket information including location, ticket price, theater, seat, and/or other possible ticket information.

The exemplary terminal 300 can further include a requesting module 305, a voice note generating module 306, and/or a sending module 307.

The requesting module 305 can be used to obtain a desired e-ticket. For example, the requesting module 305 can be configured by the user with a desired e-ticket request and send the obtained e-ticket request to an Internet interface of a client (e.g., a PC client) via the Internet such that the desired e-ticket can be subsequently searched and found. For example, when a user has a request for obtaining an e-movie ticket, the request for obtaining the e-movie ticket can be configured via the requesting module 305. Such request can be sent to the internet interface of the client via the Internet in order to subsequently search and view the e-movie ticket that matches with the configured request on websites provided by various theaters.

The voice note generating module 306 can be configured to generate an audio file according to the ticket information of the e-ticket read by the voice reading module 304. In one embodiment, the terminal can output the ticket information of the e-ticket in the form of voice message and then generate an audio file in a general format by recording the voice message of the ticket information. That is, the terminal can generate voice notes corresponding to the ticket information read by the voice message to save on the terminal. Specifically, the audio file can be in a format including a PCM (pulse code modulation) format, a WAV (wave audio files) format, an ADPCM format, an MP3 (moving picture experts group audio layer III) format, etc.

The sending module 307 can be configured to send the voice notes generated by the voice note generating module 306 to other terminals.

The user can send the voice notes saved on the terminal to one or more other terminals and to share with other users via an email and/or an MMS, or via Bluetooth, NFC, or Wi-Fi networks. In addition, the generated voice notes can be in a general format of audio files. In the case even if other terminals do not have or are not configured with a reading button, the ticket information of the e-ticket can be read by calling an audio play function in their own system of the terminals. In other words, terminals that do not have the reading button can play the received voice notes to obtain the ticket information of the e-ticket.

In the disclosed terminal 300 for processing the e-ticket, the reading button can be displayed on the page of the e-ticket. The reading button can receive the triggering command or the triggering operation from the user such that terminal 300 can output the ticket information of the e-ticket by a voice message. This resolves the problems that the user may not correctly obtain the ticket information from the e-ticket due to errors caused by human negligence or dialect accent differences. Operational efficiency can be improved to meet user's needs and to provide conveniences. In addition, by generating voice notes in a general format from the ticket information, the voice notes can be sent to other terminals that do not have or are not configured with the reading button. The other terminals can also read the ticket information by calling an audio play function in an own system.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, or apparatus having those elements.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods and terminals for processing e-tickets are provided. The terminal can include a saving module, a parsing module, and a voice reading module. The e-ticket can be obtained by a terminal. The terminal can parse contents of the e-ticket to generate ticket information of the e-ticket by triggering a reading button to call an internal program. The ticket information can be converted by the terminal into a voice message corresponding to the e-ticket. The voice message can be played by the terminal to read the ticket information of the e-ticket.

In the disclosed methods and terminals for processing the e-tickets, a reading button can be displayed on a page of an e-ticket. The reading button can receive a triggering command or a triggering operation from a user such that the exemplary terminal can output ticket information of the e-ticket by a voice message. This resolves the problems that the user may not correctly obtain the ticket information from the e-ticket due to errors caused by human negligence or due to dialect accent differences. Operational efficiency can be improved to meet user's needs and to provide conveniences. In addition, by generating voice notes in a general format from the ticket information, the voice notes can be sent to other terminals that do not have or are not configured with the reading button. The other terminals can also read the ticket information by calling an audio play function in an own system.

### REFERENCE SIGN LIST

Terminal 300
Downloading module 301
Saving module 302
Parsing module 303
Voice reading module 304
Requesting module 305
Voice note generating module 306
Sending module 307
Environment 400
Communication network 402
Server 404
Terminal 406
Processor 502
Storage medium 504
Monitor 506
Communications 508
Database 510
Peripherals 512

What is claimed is:

1. A method for processing an e-ticket comprising:
obtaining, by a terminal, the e-ticket;
parsing, by the terminal, contents of the e-ticket to generate ticket information of the e-ticket by triggering a reading button to call an internal program;
converting, by the terminal, the ticket information into a voice message corresponding to the e-ticket; and
playing, by the terminal, the voice message to read the ticket information of the e-ticket.

2. The method of claim 1, wherein, prior to obtaining the e-ticket, the method further comprises:
requesting to obtain the e-ticket;
searching for e-tickets provided by a plurality of e-commerce platforms;
selecting the e-ticket from the e-tickets provided by the plurality of e-commerce platforms; and
downloading the selected e-ticket.

3. The method of claim 1, wherein, after the obtaining of the e-ticket, the method further comprises saving the obtained e-ticket on the terminal.

4. The method of claim 1, wherein the converting of the ticket information comprises:
finding a single voice word corresponding to each character in the e-ticket;
combining single voice words into a voice word string, according to an arranged order of the each character in the e-ticket; and
generating the voice message from the combined single voice words corresponding to the e-ticket.

5. The method of claim 1, wherein, following the playing of the voice message, the method further comprises:
generating voice notes according to the ticket information of the e-ticket, wherein the voice notes include audio files having a general format.

6. The method of claim 5, wherein, following the generating of the voice notes, the method further comprises:
sending the generated voice notes to one or more additional terminals.

7. The method of claim 1, wherein the ticket information of the e-ticket comprises a string of a code or a serial number arranged in a specific format or in a specific order, and wherein each of the code or the serial number is made by a letter, a number, or a combination thereof.

8. The method of claim 1, wherein the reading button is configured to receive a triggering command from a user to read the ticket information of the e-ticket.

9. The method of claim 1, wherein the reading button includes a physical button or a software touch-control button, and the reading button is configured to receive a triggering command or a triggering operation from a user such that the terminal reads a code or a serial number in the ticket information in a form of the voice message according to an arranged order.

10. A terminal for processing an e-ticket comprising:
a saving module, configured to receive the e-ticket;
a parsing module, configured to parse contents of the e-ticket to generate ticket information of the e-ticket by triggering a reading button to call an internal program, wherein the parsing module is further configured to convert the ticket information into a voice message corresponding to the e-ticket; and
a voice reading module, configured to play the voice message to read the ticket information of the e-ticket.

11. The terminal of claim 10, wherein the terminal further comprises a requesting module configured to request to obtain the e-ticket.

12. The terminal of claim 11, wherein the terminal further comprises a downloading module configured, according to a request sent by the requesting module, to search for e-tickets provided by a plurality of e-commerce platforms; to select the e-ticket from the e-tickets provided by the plurality of e-commerce platforms; and to download the selected e-ticket.

13. The terminal of claim 10, wherein the saving module is further configured to save the received e-ticket on the terminal.

14. The terminal of claim 10, wherein the parsing module is further configured to:
find a single voice word corresponding to each character in the e-ticket;
combine single voice words into a voice word string, according to an arranged order of the each character in the e-ticket; and
generate the voice message from the combined single voice words corresponding to the e-ticket.

15. The terminal of claim 10, wherein the terminal further comprises a voice note generating module configured to generate voice notes according to the ticket information of the e-ticket, wherein the voice notes include audio files having a general format.

16. The terminal of claim 15, wherein the terminal further comprises a sending module configured to send the generated voice notes to one or more additional terminals.

17. The terminal of claim 10, wherein the ticket information of the e-ticket comprises a string of a code or a serial number arranged in a specific format or in a specific order, and wherein each of the code or the serial number is made by a letter, a number, or a combination thereof.

18. The terminal of claim 10, wherein the reading button is configured to receive a triggering command from a user to read the ticket information of the e-ticket.

19. The terminal of claim 10, wherein the reading button includes a physical button or a software touch-control button, and the reading button is configured to receive a triggering command or a triggering operation from a user such that the terminal reads a code or a serial number in the ticket information in a form of the voice message according to an arranged order.
